(19) United States
(12) Patent Application Publication
(10) Pub. No.: US 2026/0259845 A1
(43) Pub. Date: Sep. 3, 2026

(54) METHOD AND APPARATUS FOR DYNAMIC LANE CONFIGURATION DURING LANE FAILURES

(71) Applicant: QUALCOMM Incorporated, San Diego, CA (US)

(72) Inventors: Santhosh Reddy AKAVARAM, Hyderabad (IN); Sridhar ANUMALA, Hyderabad (IN); Ramacharan SUNDARARAMAN, San Jose, CA (US); Sang TRAN, Encinitas, CA (US); Chintalapati BHARATH SAI VARMA, Hyderabad (IN); Rongtian ZHANG, San Diego, CA (US)

(21) Appl. No.: 19/067,118

(22) Filed: Feb. 28, 2025

(51) Int. Cl. G06F 13/36

(52) U.S. Cl. CPC G06F 13/36; G06F 2213/40

(57) ABSTRACT

This disclosure provides systems, methods and apparatuses for communication within a chip package such as a system on chip (SoC). The chip package includes a first module and a plurality of lanes connecting the first module to a second module. The plurality of lanes include a first group of main-band lanes, a second group of side-band lanes, and a third group of common redundant lanes. The first module includes a controller configured train one or more of the common redundant lanes as one of a main-band lane or a side-band lane in response to detecting a failure of one of the main-band lanes or one of the side-band lanes.

### TECHNICAL FIELD

The present disclosure relates to integrated circuits including die-to-die interconnects with dynamic lane configuration during lane failures.

### DESCRIPTION OF THE RELATED TECHNOLOGY

A recent architecture for system-on-chip (SoC) packages involves multiple chiplets or modules. A common chiplet interconnect specification enables construction of large SoC packages that exceed maximum reticle size. It allows intermixing components from different silicon vendors within the same package and improves manufacturing yields by using smaller dies. Each chiplet can use a different silicon manufacturing process, suitable for a specific device type, or computing performance and power draw requirements. An example specification is the Universal Chiplet Interconnect Express (UCIe) specification.

### SUMMARY

The systems, methods and devices of this disclosure each have several innovative aspects, no single one of which is solely responsible for the desirable attributes disclosed herein.

In some aspects, the techniques described herein relate to an apparatus including: a first module; a plurality of lanes connecting the first module to a second module, the plurality of lanes including a first group of main-band lanes, a second group of side-band lanes, and a third group of common redundant lanes; and a controller configured train one or more of the common redundant lanes as one of a main-band lane or a side-band lane in response to detecting a failure of one of the main-band lanes or one of the side-band lanes.

In some aspects, the techniques described herein relate to a method of configuring a first module for communication with a second module via a plurality of data lanes, the plurality of lanes including a first group of main-band lanes, a second group of side-band lanes, and a third group of common redundant lanes, the method including: detecting a failure of one of the main-band lanes or one of the side-band lanes; and training one or more of the common redundant lanes as one of a main-band lane or a side-band lane in response to detecting the failure.

In some aspects, the techniques described herein relate to a package module, including: a first module; a second module; a plurality of lanes connecting the first module to a second module, the plurality of lanes including a first group of main-band lanes, a second group of side-band lanes, and a third group of common redundant lanes; and a controller at each of the first module and the second module, each controller configured train one or more of the common redundant lanes as one of a main-band lane or a side-band lane in response to detecting a failure of one of the main-band lanes or one of the side-band lanes.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a standard package with interconnected modules.

FIG. 2 is a diagram illustrating an example of an advanced package with interconnected modules.

FIG. 3 is a diagram of an example die-to-die adapter and interface of a chiplet.

FIG. 4 is a diagram of example lane configuration of an interconnect.

FIG. 5 is a diagram of an example die-to-die adapter and interface of a chiplet with common redundant lanes

FIG. 6 is a state diagram of initialization of a chiplet interface.

FIG. 7 is a circuit diagram of a transmission side of a chiplet interface.

FIG. 8 is a circuit diagram of a reception side of a chiplet interface.

FIG. 9 is a flowchart of an example method of configuring a first module for communication with a second module via a plurality of data lanes

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on the Universal Chiplet Interconnect Express (UCIe) specification. In particular, some examples are for advanced driver assistance systems (ADAS) that satisfy specific automotive safety integrity levels (ASILs). However, the apparatuses and techniques described herein may be implemented in any device, system or network regardless of compliance any particular standard specification.

In some implementations, the packages described herein may implement wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, 6G or further implementations thereof, technology.

The UCle specifications have two different packaging options: standard package (2D) and advanced package (2.5D). The standard package may be used for low cost and long reach (e.g., 10 mm to 25 mm) interconnects using traces on organic package or substrate. The standard package has 16 data lanes and no extra lanes are provided for the purpose of repair. The advanced package may be used for performance optimized applications with short channel length (e.g., less then 2 mm). The advanced package has 32 or 64 data lanes and additionally has two or four redundant lanes which can be utilized in the case of repair. For instance, implementations with 32 data lanes may have 2 redundant lanes for repair, and implementations with 64 data lanes may have 4 redundant lanes for repair.

Several aspects of system-on-chip (SoC) will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

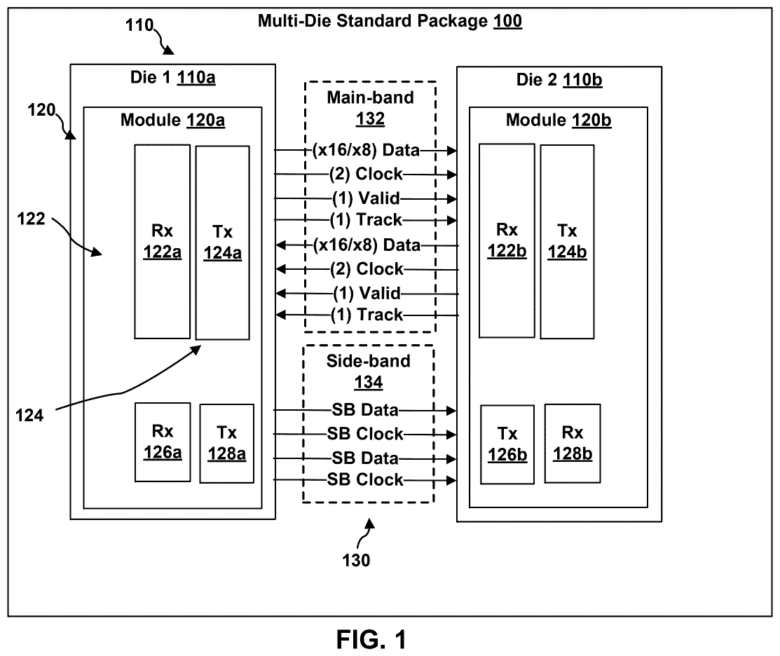

FIG. 1 is a diagram illustrating an example of a standard package 100 with interconnected modules 120a and 120b. The package 100 may include two or more dies 110 (e.g., 110a and 110b). Each die 110 may include a module 120. A module 120 may alternatively be referred to as a chiplet. Each module 120 may be independently fabricated, for example, by a same or different silicon vendor. In some implementations, each module may have a specific function such as image processing, signal processing, AI processing, etc.

An interface 130 may provide communications between the modules 120. For example, the interface 130 may include a plurality of lanes connecting the modules 120. For instance, the lanes may be traces in a substrate. Each module 120 may include one or more receive (Rx) circuits 122 and transmit (Tx) circuits 124. The interface 130 and the Rx circuits and Tx circuits may be divided into a main-band 132 and a side-band 134. For example, the module 120a may include a Rx circuit 122a and Tx circuit 124a for the main-band 132 and a Rx circuit 126a and Tx circuit 128a for the side-band 134. The module 120b may include a Rx circuit 122b and Tx circuit 124b for the main-band 132 and a Rx circuit 126b and Tx circuit 128b for the side-band 134.

In the illustrated example, the main-band 132 may include, in each direction, 8 or 16 lanes for data, 2 lanes for clock, 1 lane for valid indication, and 1 lane for tracking. The side-band may include a data lane and a clock lane in each direction.

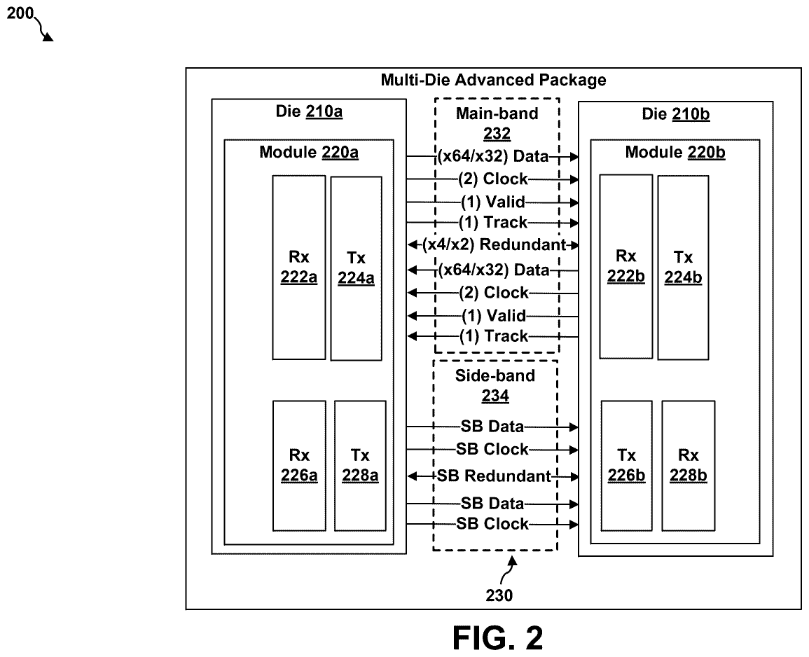

FIG. 2 is a diagram illustrating an example of an advanced package 200 with interconnected modules 220a and 220b on respective dies 210a and 210b. The package 200 may be similar to the package 100, except the package 200 may include additional lanes connecting the module 220a and the module 220b. For example, the main-band 132 may include, in each direction, 32 or 64 lanes for data, 2 lanes for clock, 1 lane for valid indication, and 1 lane for tracking. The main-band 232 may also include redundant lanes for data and/or clock and tracking. The redundant lanes allow repair of other lanes. For example, if a fault is detected on a data lane, the Rx circuit 222a or 222b and/or Tx circuit 224a or 224b may be reconfigured to transmit and receive corresponding signals over one of the redundant lanes. For instance, the signals associated with the faulty lane may be remapped to the redundant lanes. Similarly, the side-band 234 may include redundant data lanes and redundant clock lanes that may be used by the Rx circuit 226a or 226b and/or Tx circuit 228a or 228b to repair the data and clock lanes. Accordingly, the advanced package 200 may tolerate some faults in the interface 230.

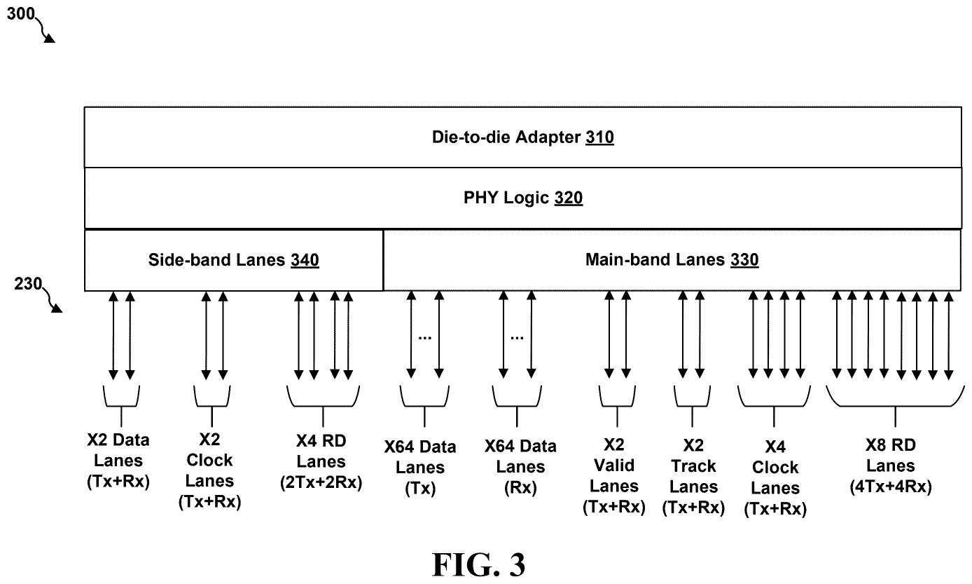

FIG. 3 is a diagram 300 of an example die-to-die adapter 310 and interface 230 of a chiplet. The die-to-die adapter includes PHY logic 320, main-band lanes 330, and side-band lanes 340. The PHY logic controls initialization and training of the interface 230. The PHY logic 320 maps main-band signals to main-band lanes 330 and maps side-band signals to side-band lanes 340.

The interface 230 includes designated lanes for the main-band and the side-band. For example, in the illustrated example of a module for an advanced package with 64 data lanes, the interface 230 for the side-band includes 2 data lanes (for Tx and Rx), 2 clock lanes (for Tx and Rx), and 4 redundant lanes. There is one redundant lane for each of the data and clock lanes. For the main-band, the interface 230 includes 64 data lanes for Tx, 64 data lanes for Rx, 2 valid lanes (1 Tx and 1 Rx), 2 track lanes (1 Tx and 1 Rx), 4 clock lanes (2 Tx and 2 Rx) and 8 redundant lanes (4 Tx and 4 Rx). In some implementations, there is one or more additional redundant lanes for the valid and/or track lanes.

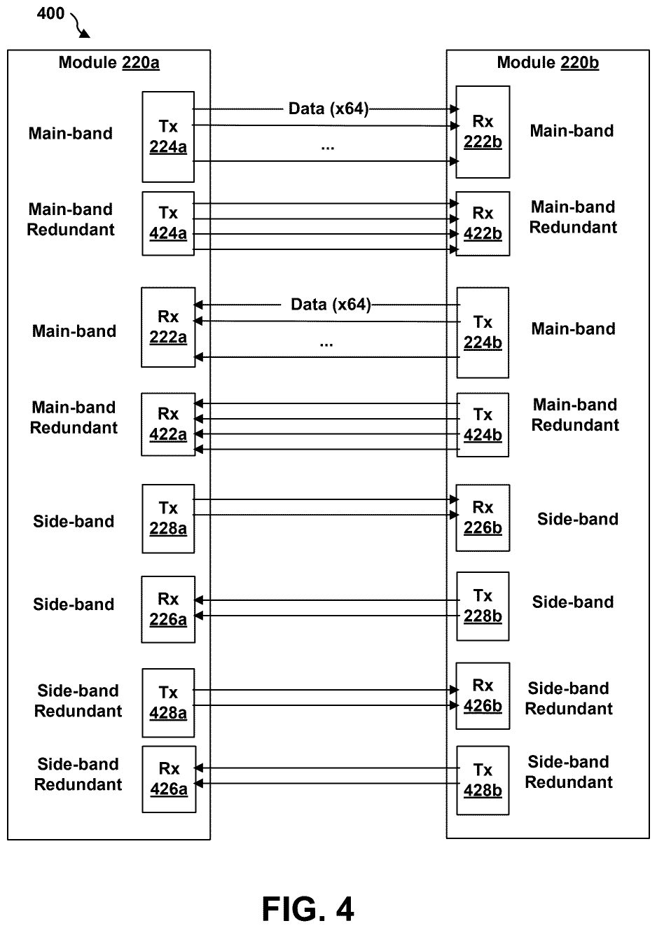

FIG. 4 is a diagram 400 of example lane configuration of an interface having redundant lanes. The redundant lanes include main-band redundant receive lanes 422a and 422b, main-band redundant transmit lanes 424a and 424b, sideband redundant receive lanes 426a and 426b, and sideband redundant transmit lanes 428a and 428b. Each of the redundant lanes can be trained to serve as another lane in the same band and in the same direction. For example, when a lane is detected as faulty, the signal for the faulty lane can be selected as the input for a redundant lane at the transmitter. The redundant lane can be selected as the source of the signal at the receiver.

In some implementations, there are four redundant main-band data transmission lanes in each direction. The redundant main-band transmission lanes may provide redundancy for a group of main-band transmission lanes (e.g., 16 lanes). Some of the main-band redundant lanes may be associated with control signals such as clock, valid, and track signals. The sideband redundant lanes may include a data lane and a clock lane in each direction that provide redundancy for the sideband clock and data lanes.

In an aspect, applications of multi-die packages in the automotive space may require high levels of reliability. For example, ADAS components may be required to satisfy ASIL-D, the highest level of reliability and safety. Although the redundant lanes of the advanced package 200 provide some ability to repair faulty links to transfer data, further improvements to reliability are desirable. In particular, the advanced package 200 defines the redundant lanes for specific types of signals within specific bands (main-band or side-band). Generally, the number of faults that can be repaired is equal to the number of redundant lanes of each signal type. For instance, 4 redundant main-band data lanes may allow repair of 4 main-band data lanes. If the number of faulty lanes exceeds the number of redundant lanes, the entire interface 230 may be inoperable (i.e., zero bandwidth). Similarly, the signals with only one corresponding redundant lane may only allow repair of one faulty lane.

In an aspect, the present disclosure provides for common redundant lanes that can be mapped to either main-band signals or side-band signals to repair a faulty lane in either band. The use of common redundant lanes can effectively increase the number of faults that can be repaired for a package having the same total number of lanes. The present disclosure further provides for registers, logic, and methods for configuring a module to initialize the interface for use of the common redundant lanes.

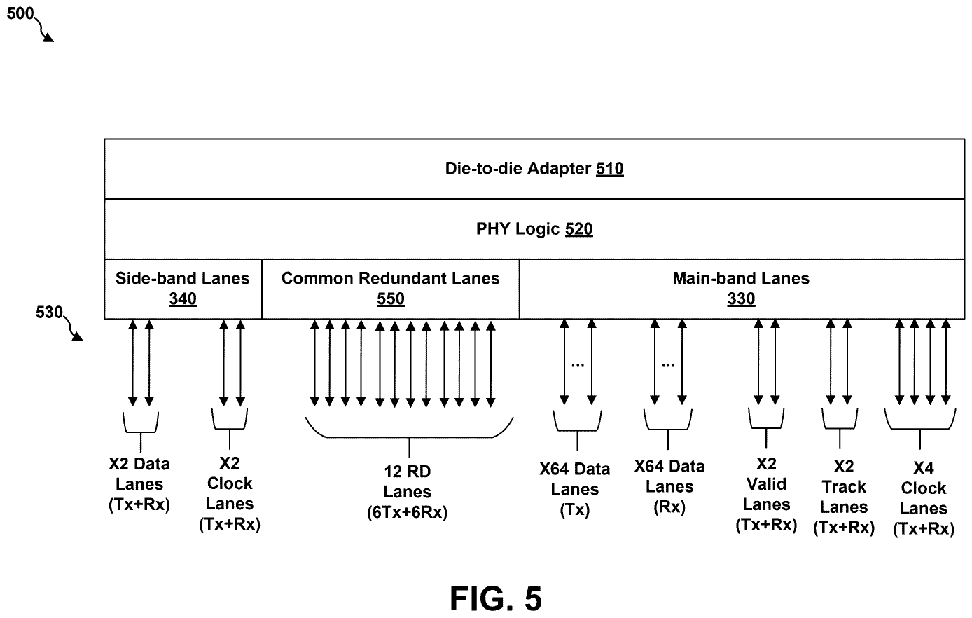

FIG. 5 is a diagram of an example die-to-die adapter 510 and interface 530 of a chiplet with common redundant lanes 550. The die-to-die adapter 510 may be similar to the die-to-die adapter 310 with respect to the main-band and side-band lanes. The die-to-die adapter 510 includes PHY logic 520 that is configured to control initialization and training of the interface 530. The PHY logic 520 may be a controller configured train one or more of the common redundant lanes 550 as one of a main-band lane 330 or a side-band lane 340 in response to detecting a failure of one of the main-band lanes or one of the side-band lanes. The PHY logic 520 also controls mapping of the common redundant lanes 550 to signals associated with faulty main-band or side-band lanes.

The interface 530 includes designated lanes for the main-band and the side-band. For example, in the illustrated example of a module for an advanced package with 64 data lanes, the interface 530 includes, for the side-band, 2 data lanes (for Tx and Rx) and 2 clock lanes. For the main-band, the interface 530 includes 64 data lanes for Tx, 64 data lanes for Rx, 2 valid lanes (1 Tx and 1 Rx), 2 track lanes (1 Tx and 1 Rx), and 4 clock lanes (2 Tx and 2 Rx). The interface 530 also includes 12 common redundant lanes (6 Tx and 6 Rx) that can be used for either main-band or side-band data. In some implementations, there is one or more additional redundant lanes for the valid and/or track lanes.

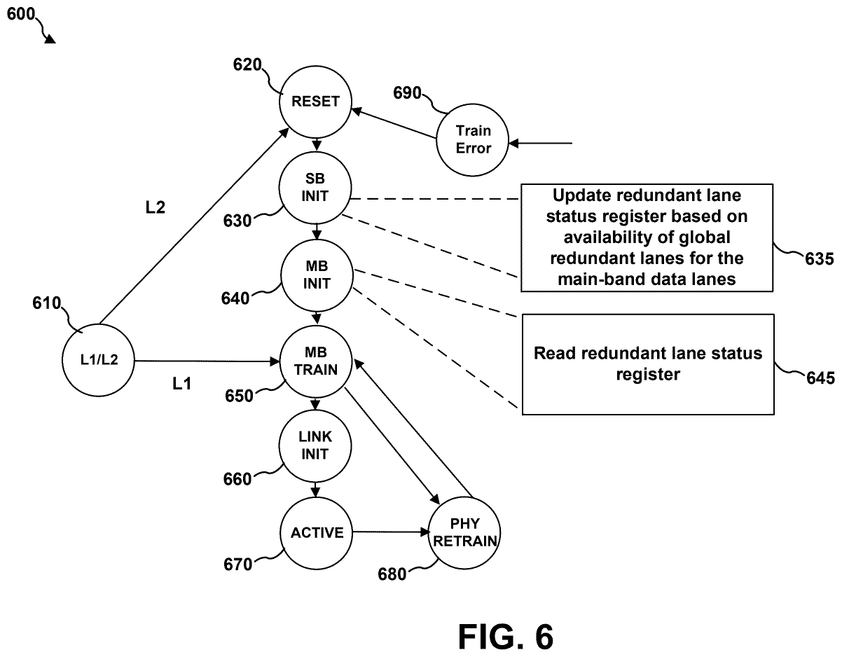

FIG. 6 is a state diagram 600 of initialization of a chiplet interface. For example, the state diagram 600 may represent states of the die-to-die adapter 510 and/or the PHY logic 520. The state diagram 600 illustrates PHY layer states to initialize the main-band, side-band, and redundant lanes, and train the lanes for carrying signals.

In state 610 a signal may be received indicating a need to update the chiplet interface. The signal may be received from L1 or L2. If received from L2, a full reset may be performed (e.g., because a lane is faulty). If received from L1, there may be an error that can be resolved by retraining the lanes.

If the signal is received from L2, the state may transition to a reset state 620. In some implementations, the reset state 620 may also be reached when a training error is detected in state 690, which can be reached from any state.

After reset, the state transitions to a side-band (SB) initialization (INIT) state. In the SB INIT state 630, the die-to-die adapter 510 may map side-band signals to lanes. If there are no faults detected in the side-band lanes, the side-band signals can be mapped to initially designated side-band lanes. If a fault is detected in one or more side-band lanes, the signal associated with a faulty lane may be mapped to one of the common redundant lanes 550. For instance, the PHY logic 520 may include a register that indicates a selected signal for each of the common redundant lanes 550. The SB INIT state 630 may set the value of the register.

In some implementations, the PHY logic 520 includes a redundant lane status register that indicates whether redundant lanes are available to the main-band. For example, the redundant lane status register may indicate a status as Tx and Rx lanes are not available, Tx lane is available, Rx lane is available, or Tx and RX lanes are available. Upon completion of side-band initialization, at block 635, the SB INIT state 630 can update the redundant lane status register based on availability of common redundant lanes for the main-band data lanes. The SB INIT state 630 transitions to the main-band (MB) INIT state 640 upon completion of initialization.

In the MB INIT state 640, the die-to-die adapter 510 may map main-band signals to lanes. Similar to the SB INIT state 630, if there are no faults detected in the main-band lanes 330, the PHY logic 520 may map the main-band signals to the initially designated main-band lanes. If a fault is detected in the main-band lanes, the PHY logic 520 can read the redundant lane status register at block 645. If a common redundant lane is available in the direction of the faulty main-band lane, the PHY logic 520 can map the main-band signal corresponding to the faulty lane to a common redundant lane 550. If no common redundant lane 550 in the correct direction is available, communication over the interface 530 may not be possible. The MB INIT state 640 transitions to the MB TRAIN state 650 upon completion of lane mapping.

The MB TRAIN state 650 may be reached from the MB INIT state 640, from the state 610 when a signal is received from L1, or from the PHY RETRAIN state 680 when the PHY layer detects an error. The MB TRAIN state trains the main-band lanes 330. For example, the data lanes may be synchronized via the clock lanes. The MB INIT state 640 transitions to the LINK INIT state 660 upon completion of main-band lane training.

In the LINK INIT state 660 the die-to-die adapter 510 may initialize the link between the first module 220a and the second module 220b. For example, the modules may exchange capability information. For instance, the capability information may include a value of the redundant lane register (EXT_RD_Lane) configured to indicate a capability of using the common redundant lanes as either a main-band lane or a side-band lane. The LINK INIT state 660 may transition to the active state 670.

In the ACTIVE state 670, the first module 220a and the second module 220b may communicate over the main-band 232. For example, the communication over the main-band 232 may use the multiple data lanes including the common redundant lanes that have been mapped to the main-band data signals. The ACTIVE state 670 may transition to the PHY RETRAIN state 680 when an error is detected at the physical layer (e.g., a low or no power signal).

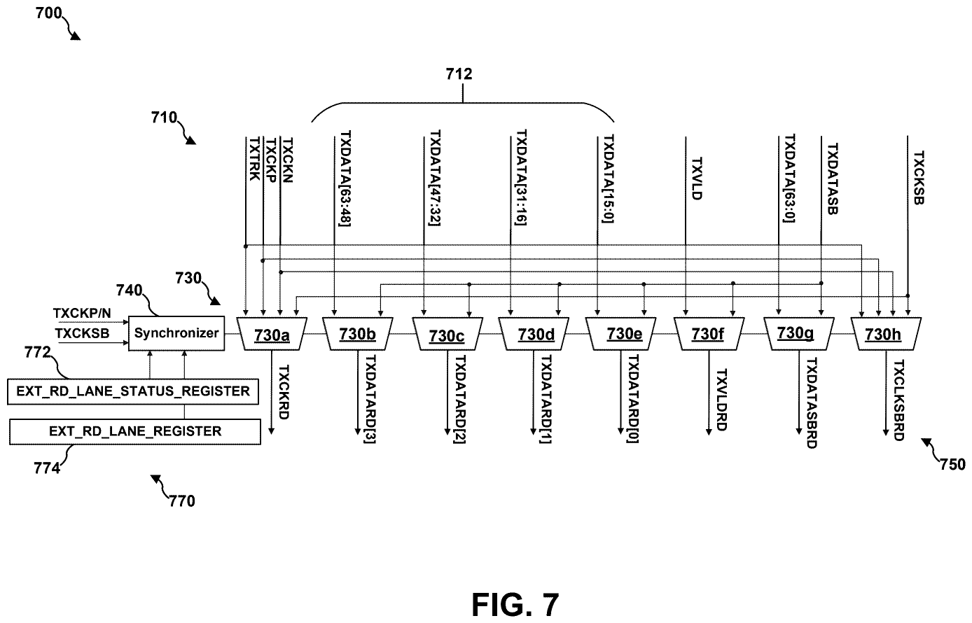

FIG. 7 is a circuit diagram 700 of a transmission side of the chiplet interface 500 for the redundant lanes 550. The circuit diagram 700 illustrates mapping of transmission signals 710 to redundant Tx lanes 750 via multiplexors 730. The select line of the multiplexors 730 may be set based on the status of the registers 770 determined during the initialization states discussed above with respect to FIG. 6. For instance, a synchronizer 740 may select an input of each of the multiplexors 730 based on values of the EX_RD_LANE_STATUS_REGISTER 772 and/or EXT_RD_LANE_REGISTER 774.

The transmission signals 710 include the transmission data (TXDATA), transmit data valid (TXVALID), transmit track signal (TXTRK), transmit clock phase-1 (TXCKP), transmit clock phase-2 (TXCKN), the side-band transmit data (TXDATASB), and the transmit side-band clock (TXCKSB). Each of the transmission signals is mapped to a respective lane of the main-band lanes 330 or side-band lanes 340 (not shown). Each of the transmission signals may also be coupled to one of the redundant lanes via the illustrated circuit. In the illustrated example, the TXDATA signals may be divided into different groups 712. For example, the 64 data signals may be divided into 4 groups of 16. The synchronizer 740 may also clock the redundant lanes based on the TXCKP, TXCPN, and TXCKSB signals.

The redundant lanes 750 may be associated with a plurality of transmit signals. The multiplexors 730 may selectively couple one of the transmit signals to the redundant lane 750. For example, a redundant transmit clock (TXCKRD) lane 730a may be selectively coupled to one of TXTRK, TXCKP, TXCKN, or TXCKSB. Redundant data lanes (TXDATARD[i]) may be selectively coupled to one of the TXDATA of the respective group 712 or the TXDATASB. A redundant transmit valid (TXVLDRD) lane 730f may be selectively coupled to one of TXVLD or TXDATASB. A redundant side-band data (TXDATSBRD) lane may be selectively coupled to the TXDATASB or any of the TXDATA. A clock side-band redundant (TXCLKSBRD) lane 730h may be selectively coupled to TXCKSB, TXCKN, TXCKP, or TXTRK.

The above example mapping may provide multiple redundant lanes for most of the signals. As illustrated, TXVLD is the exception, but could be mapped to another redundant lane if desired. The availability of multiple redundant lanes provides increased reliability in case of a fault on a specified lane and one redundant lane.

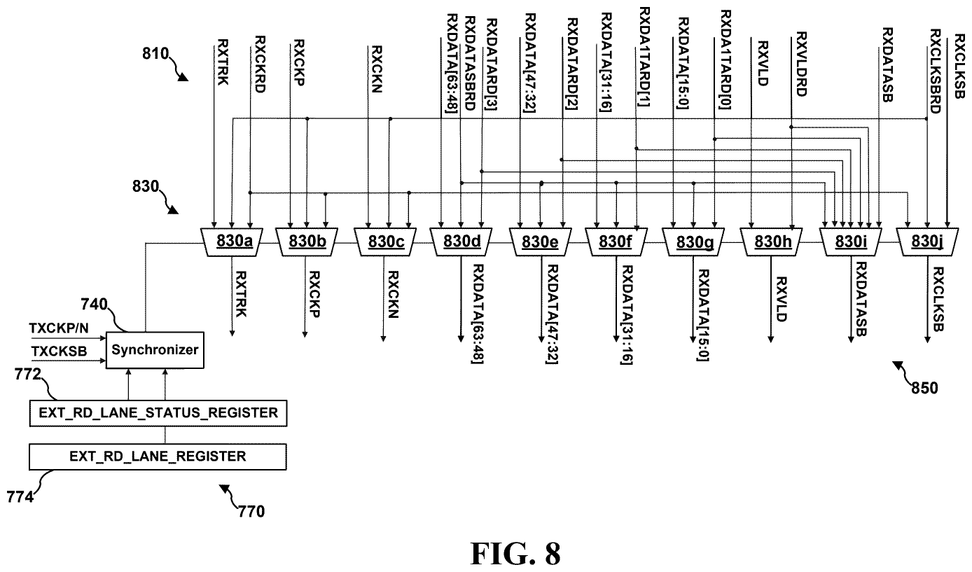

FIG. 8 is a circuit diagram of a reception side of a chiplet interface 500 for receive lanes 810 including main-band lanes 330, side-band lanes 340, and common redundant lanes 550. The circuit diagram 700 illustrates mapping of the receive lanes 810 to receive signals 850 via multiplexors 830. The select lines of the multiplexors 830 may be set based on the status of the registers 770 determined during the initialization states discussed above with respect to FIG. 6. For instance, a synchronizer 740 may select an input of each of the multiplexors 830 based on values of the EX_RD_LANE_STATUS_REGISTER 772 and/or EXT_RD_LANE_REGISTER 774.

Each of the multiplexors 830 selectively couples one of the receive lanes to a receive signal. For example, the multiplexor 830a selects one of the receive track (RXTRK) lane, the redundant side-band receive clock (RXCLKSBRD) lane, or the redundant received clock (RXCKRD) lane as the receive track (RXTRK) signal. The multiplexor 830b selects one of the receive clock phase-1 (RXCKP) lane, RXCLKSBRD lane or the RXCKRD as the RXCKP signal. The multiplexor 830c selects one of the receive clock phase-2 (RXCKN) lane, the RXCLKSBRD lane, or the RXCKRD lane as the RXCKN signal. Each of multiplexors 830d-g selects one of a corresponding data lanes (RXDATA[i]), a corresponding redundant data lane (RXDATARD[i]), or the redundant receive side-band data (RXDATASBRD) lane as a respective RX data signal. The multiplexor 830h selectively couples one of the receive valid (RXVLD) or the redundant receive valid (RXVLDRD) to the receive valid signal. The multiplexor 830i selects one of the receive side-band data (RXDATASB) lane, one of the redundant receive data side-band (RXDATASBRD) lanes, or the redundant receive data (RXDATARD) lanes as the RXDATASB signal. The multiplexor 830 j selects one of the receive side-band clock (RXCKSB) lane, the RXCLKSBRD lane, or the RXCKRD as the RXCKSB signal.

The selection of the signal from among the multiple redundant lanes mapped to each receive signal allows reception of the correct signal in the case of one or two faulty lanes.

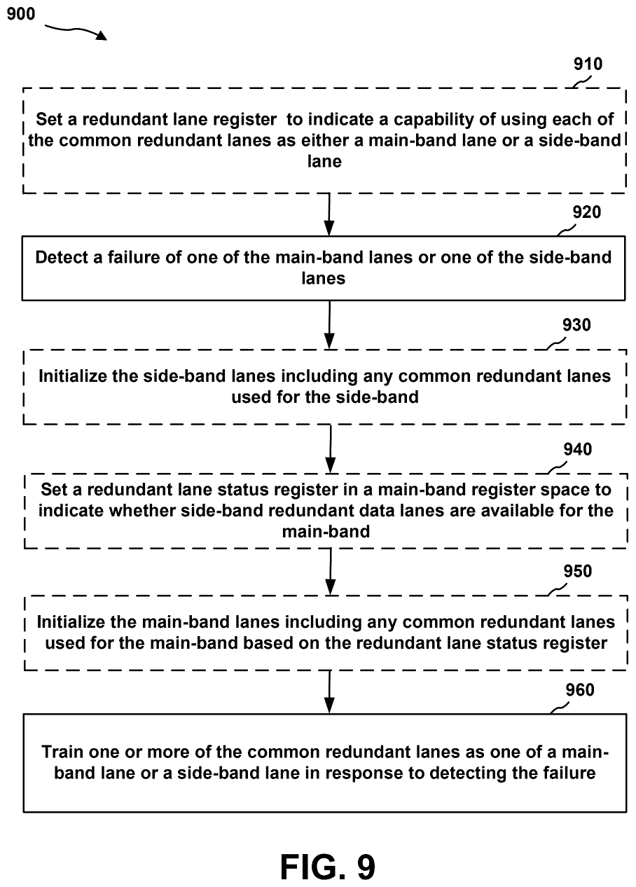

FIG. 9 is a flowchart of an example method 900 of configuring a first module 220a for communication with a second module 220b via a plurality of data lanes. The method 900 may be performed by the first module 220a or a component thereof such as the die-to-die adapter 510, and/or the PHY logic 520. The method 900 may be performed by the first module 220a in communication with the second module 220b. Optional blocks are shown with dashed lines.

At block 910, the method 900 may optionally include setting a redundant lane register to indicate a capability of using each of the common redundant lanes as either a main-band lane or a side-band lane. In some implementations, for example, the first module 220a and/or the die-to-die adapter 510 may set the redundant lane register 774 to indicate a capability of using each of the common redundant lanes 550 as either a main-band lane or a side-band lane. Accordingly, the first module 220a and/or the die-to-die adapter 510 may provide means for setting a redundant lane register to indicate a capability of using each of the common redundant lanes as either a main-band lane or a side-band lane.

At block 920, the method 900 includes detecting a failure of one of the main-band lanes or one of the side-band lanes. In some implementations, for example, the first module 220a and/or the die-to-die adapter 510 may detect a failure of one of the main-band lanes 330 or one of the side-band lanes 340. Accordingly, the first module 220a and/or the die-to-die adapter 510 may provide means for detecting a failure of one of the main-band lanes or one of the side-band lanes.

At block 930, the method 900 may optionally include initializing the side-band lanes including any common redundant lanes used for the side-band. In some implementations, for example, the first module 220a and/or the die-to-die adapter 510 may initialize the side-band lanes including any common redundant lanes used for the side-band. Accordingly, the first module 220a and/or the die-to-die adapter 510 may provide means for initializing the side-band lanes including any common redundant lanes used for the side-band.

At block 940, the method 900 may optionally include setting a redundant lane status register in a main-band register space to indicate whether side-band redundant data lanes are available for the main-band. In some implementations, for example, the first module 220a and/or the die-to-die adapter 510 may set a redundant lane status register 772 in a main-band register space to indicate whether side-band redundant data lanes are available for the main-band. For instance, the redundant lane status register 772 may indicate whether side-band redundant data lanes are available in one or both of the transmit and receive directions. Accordingly, the first module 220a and/or the die-to-die adapter 510 may provide means for setting a redundant lane status register in a main-band register space to indicate whether side-band redundant data lanes are available for the main-band. At block 950, the method 900 may optionally include initializing the main-band lanes including any common redundant lanes used for the main-band based on the redundant lane status register. In some implementations, for example, the first module 220a and/or the die-to-die adapter 510 may initialize the main-band lanes including any common redundant lanes used for the main-band based on the redundant lane status register. In some implementations, a faulty main band lane may result in an asymmetric transmit and receive redundant lane configuration. In some implementations, the block 950 may optionally include: detecting a non-functional main-band lane; determining an asymmetric transmit and receive redundant lane configuration; and configuring a main-band transmit configuration register or a main-band receive configuration register to indicate an additional redundant lane. Accordingly, the first module 220a and/or the die-to-die adapter 510 may provide means for initializing the main-band lanes including any common redundant lanes used for the main-band based on the redundant lane status register.

At block 960, the method 900 includes training one or more of the common redundant lanes as one of a main-band lane or a side-band lane in response to detecting the failure. In some implementations, for example, the first module 220a and/or the die-to-die adapter 510 may train one or more of the common redundant lanes as one of a main-band lane or a side-band lane in response to detecting the failure. Accordingly, the first module 220a and/or the die-to-die adapter 510 may provide means for training one or more of the common redundant lanes as one of a main-band lane or a side-band lane in response to detecting the failure.

The following numbered clauses provide an overview of aspects of the present disclosure:

Clause 1. An apparatus comprising: a first module; a plurality of lanes connecting the first module to a second module, the plurality of lanes including a first group of main-band lanes, a second group of side-band lanes, and a third group of common redundant lanes; and a controller configured train one or more of the common redundant lanes as one of a main-band lane or a side-band lane in response to detecting a failure of one of the main-band lanes or one of the side-band lanes.

Clause 2. The apparatus of clause 1, wherein the controller includes a redundant lane register configured to indicate a capability of using the common redundant lanes as either a main-band lane or a side-band lane.

Clause 3. The apparatus of clause 1 or 2, wherein the controller includes a redundant lane status register in a main-band register space configured to indicate whether side-band redundant data lanes are available for the main-band.

Clause 4. The apparatus of clause 3, wherein the redundant lane status register indicates availability of the side-band redundant data lanes for one or both of a transmit or a receive direction.

Clause 5. The apparatus of clause 3 or 4, wherein the controller is configured to: initialize the side-band lanes including any common redundant lanes used for the side-band; set the redundant lane status register based on the common redundant lanes used for the side-band; initialize the main-band lanes including any common redundant lanes used for the main-band based on the redundant lane status register.

Clause 6. The apparatus of any of clauses 1-5, wherein the controller is configured to: detect a non-functional main-band lane; determine that an asymmetric transmit and receive redundant lane configuration; and configure a main-band transmit configuration register or a main-band receive configuration register to indicate an additional redundant lane.

Clause 7. The apparatus of any of clauses 1-6, wherein the first module is a universal chiplet interconnect express chiplet.

Clause 8. The apparatus of any of clauses 1-7, wherein each common redundant lane is coupled to at least one main-band lane and at least one side-band lane via a multiplexor.

Clause 9. The apparatus of any of clauses 1-8, wherein the common redundant lanes include a redundant lane for clock and track repair, a plurality of lanes for transmit data repair, a redundant lane for transmit valid repair, a redundant lane for side-band transmit data, and a redundant lane for side-band transmit clock, wherein the plurality of lanes for transmit data repair and the redundant lane for side-band transmit data are coupled with each of a plurality of main-band transmit data lanes and a side-band transmit data lane via respective multiplexors, wherein the redundant lane for clock and track repair and the redundant lane for side-band transmit clock are coupled with a transmit track signal lane, a transmit clock phase one lane, a transmit clock phase two lane, and side-band transmit clock lane via respective multiplexors, wherein the redundant lane for transmit valid repair is coupled with a transmit valid lane and the side-band transmit data lane via a multiplexor.

Clause 10. The apparatus of any of clauses 1-9, wherein the common redundant lanes include a redundant lane for clock and track repair, a plurality of lanes for receive data repair, a redundant lane for receive valid repair, a redundant lane for side-band receive data, and a redundant lane for side-band receive clock, wherein the plurality of lanes for receive data repair and the redundant lane for side-band transmit data are coupled with each of a plurality of main-band receive data lanes and a side-band receive data lane via respective multiplexors, wherein the redundant lane for clock and track repair and the redundant lane for side-band receive clock are coupled with a receive track signal lane, a transmit clock phase one lane, a transmit clock phase two lane, and side-band transmit clock lane via respective multiplexors, wherein the redundant lane for receive valid repair is coupled with a receive valid lane and the side-band receive data lane via a multiplexor.

Clause 11. A method of configuring a first module for communication with a second module via a plurality of data lanes, the plurality of lanes including a first group of main-band lanes, a second group of side-band lanes, and a third group of common redundant lanes, the method comprising: detecting a failure of one of the main-band lanes or one of the side-band lanes; and training one or more of the common redundant lanes as one of a main-band lane or a side-band lane in response to detecting the failure.

Clause 12. The method of clause 11, further comprising setting a redundant lane register to indicate a capability of using each of the common redundant lanes as either a main-band lane or a side-band lane.

Clause 13. The method of clause 11 or 12, further comprising setting a redundant lane status register in a main-band register space to indicate whether side-band redundant data lanes are available for the main-band.

Clause 14. The method of clause 13, wherein the redundant lane status register indicates availability of the side-band redundant data lanes for one or both of a transmit or a receive direction.

Clause 15. The method of clause 13 or 14, further comprising: initializing the side-band lanes including any common redundant lanes used for the side-band; setting the redundant lane status register based on the common redundant lanes used for the side-band; initializing the main-band lanes including any common redundant lanes used for the main-band based on the redundant lane status register.

Clause 16. The method of any of clauses 11-15, further comprising: detecting a non-functional main-band lane; determining an asymmetric transmit and receive redundant lane configuration; and configuring a main-band transmit configuration register or a main-band receive configuration register to indicate an additional redundant lane.

Clause 17. The method of any of clauses 11-16, wherein the first module is a universal chiplet interconnect express chiplet.

Clause 18. A package module, comprising: a first module; a second module; a plurality of lanes connecting the first module to a second module, the plurality of lanes including a first group of main-band lanes, a second group of side-band lanes, and a third group of common redundant lanes; and a controller at each of the first module and the second module, each controller configured train one or more of the common redundant lanes as one of a main-band lane or a side-band lane in response to detecting a failure of one of the main-band lanes or one of the side-band lanes.

Clause 19. The package module of clause 18, wherein the first module or the second module is configured according to any of clauses 1-10.

As used herein, a phrase referring to “at least one of” a list of items refers to any combination of those items, including single members. As an example, “at least one of: a, b, or c” is intended to cover: a, b, c, a-b, a-c, b-c, and a-b-c. Similarly, as used herein, a phrase referring to “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a first module;
a plurality of lanes connecting the first module to a second module, the plurality of lanes including a first group of main-band lanes, a second group of side-band lanes, and a third group of common redundant lanes; and
a controller configured train one or more of the common redundant lanes as one of a main-band lane or a side-band lane in response to detecting a failure of one of the main-band lanes or one of the side-band lanes.

2. The apparatus of claim 1, wherein the controller includes a redundant lane register configured to indicate a capability of using the common redundant lanes as either a main-band lane or a side-band lane.

3. The apparatus of claim 1, wherein the controller includes a redundant lane status register in a main-band register space configured to indicate whether side-band redundant data lanes are available for the main-band.

4. The apparatus of claim 3, wherein the redundant lane status register indicates availability of the side-band redundant data lanes for one or both of a transmit or a receive direction.

5. The apparatus of claim 3, wherein the controller is configured to:
initialize the side-band lanes including any common redundant lanes used for the side-band;
set the redundant lane status register based on the common redundant lanes used for the side-band;
initialize the main-band lanes including any common redundant lanes used for the main-band based on the redundant lane status register.

6. The apparatus of claim 1, wherein the controller is configured to:
detect a non-functional main-band lane;
determine an asymmetric transmit and receive redundant lane configuration; and
configure a main-band transmit configuration register or a main-band receive configuration register to indicate an additional redundant lane.

7. The apparatus of claim 1, wherein the first module is a universal chiplet interconnect express chiplet.

8. The apparatus of claim 1, wherein each common redundant lane is coupled to at least one main-band lane and at least one side-band lane via a multiplexor.

9. The apparatus of claim 1, wherein the common redundant lanes include a redundant lane for clock and track repair, a plurality of lanes for transmit data repair, a redundant lane for transmit valid repair, a redundant lane for side-band transmit data, and a redundant lane for side-band transmit clock,
wherein the plurality of lanes for transmit data repair and the redundant lane for side-band transmit data are coupled with each of a plurality of main-band transmit data lanes and a side-band transmit data lane via respective multiplexors,
wherein the redundant lane for clock and track repair and the redundant lane for side-band transmit clock are coupled with a transmit track signal lane, a transmit clock phase one lane, a transmit clock phase two lane, and side-band transmit clock lane via respective multiplexors,
wherein the redundant lane for transmit valid repair is coupled with a transmit valid lane and the side-band transmit data lane via a multiplexor.

10. The apparatus of claim 1, wherein the common redundant lanes include a redundant lane for clock and track repair, a plurality of lanes for receive data repair, a redundant lane for receive valid repair, a redundant lane for side-band receive data, and a redundant lane for side-band receive clock,
wherein the plurality of lanes for receive data repair and the redundant lane for side-band transmit data are coupled with each of a plurality of main-band receive data lanes and a side-band receive data lane via respective multiplexors,
wherein the redundant lane for clock and track repair and the redundant lane for side-band receive clock are coupled with a receive track signal lane, a transmit clock phase one lane, a transmit clock phase two lane, and side-band transmit clock lane via respective multiplexors,
wherein the redundant lane for receive valid repair is coupled with a receive valid lane and the side-band receive data lane via a multiplexor.

11. A method of configuring a first module for communication with a second module via a plurality of data lanes, the plurality of lanes including a first group of main-band lanes, a second group of side-band lanes, and a third group of common redundant lanes, the method comprising:
detecting a failure of one of the main-band lanes or one of the side-band lanes; and
training one or more of the common redundant lanes as one of a main-band lane or a side-band lane in response to detecting the failure.

12. The method of claim 11, further comprising setting a redundant lane register to indicate a capability of using each of the common redundant lanes as either a main-band lane or a side-band lane.

13. The method of claim 11, further comprising setting a redundant lane status register in a main-band register space to indicate whether side-band redundant data lanes are available for the main-band.

14. The method of claim 13, wherein the redundant lane status register indicates availability of the side-band redundant data lanes for one or both of a transmit or a receive direction.

15. The method of claim 13, further comprising:
initializing the side-band lanes including any common redundant lanes used for the side-band;
setting the redundant lane status register based on the common redundant lanes used for the side-band;
initializing the main-band lanes including any common redundant lanes used for the main-band based on the redundant lane status register.

16. The method of claim 11, further comprising:
detecting a non-functional main-band lane;
determining an asymmetric transmit and receive redundant lane configuration; and
configuring a main-band transmit configuration register or a main-band receive configuration register to indicate an additional redundant lane.

17. The method of claim 11, wherein the first module is a universal chiplet interconnect express chiplet.

18. A package module, comprising:
a first module;
a second module;
a plurality of lanes connecting the first module to a second module, the plurality of lanes including a first group of main-band lanes, a second group of side-band lanes, and a third group of common redundant lanes; and
a controller at each of the first module and the second module, each controller configured train one or more of the common redundant lanes as one of a main-band lane or a side-band lane in response to detecting a failure of one of the main-band lanes or one of the side-band lanes.

19. The package module of claim 18, wherein the controller includes a redundant lane status register in a main-band register space configured to indicate whether side-band redundant data lanes are available for the main-band.

20. The package module of claim 19, wherein the controller is configured to:
initialize the side-band lanes including any common redundant lanes used for the side-band;
set the redundant lane status register based on the common redundant lanes used for the side-band;
initialize the main-band lanes including any common redundant lanes used for the main-band based on the redundant lane status register.
